(19) United States
(12) Patent Application Publication
(10) Pub. No.: US 2023/0066294 A1
(43) Pub. Date: Mar. 2, 2023

(54) WALL PORTAL AND CONDUIT ASSEMBLY

(71) Applicant: William Joseph Brown, Liberty, KY (US)

(72) Inventor: William Joseph Brown, Liberty, KY (US)

(21) Appl. No.: 17/464,362

(22) Filed: Sep. 1, 2021

(51) Int. Cl. F16L 5/00; F16L 15/00

(52) U.S. Cl. CPC F16L 5/00; F16L 15/006

(57) ABSTRACT

A conduit assembly comprising an inner sleeve and an outer sleeve, the inner sleeve and outer sleeve being proportioned to form a concentric engagement with one another defining a longitudinal inner conduit, each of the inner sleeve and the outer sleeve having a flange end, the flange end surrounding a conduit port, wherein each of the flange ends have an inner side defining an axial shoulder and an outer side including a radially inner chamfered edge surrounding a periphery of the conduit port and a radially outer chamfered edge surrounding a periphery of the flange end.

### BACKGROUND OF THE INVENTION

### Field of the Invention

The invention is generally directed to an assembly for securely disposing wires, cables, cords, tubes or other elongated conductors used for data and electrical communication through home structures such as walls after such structures have been erected which forms a functional port for such conductors while maintaining an aesthetically desirable appearance.

### Background

There exists wall systems, receptacles and ports available in the market today which are intended to be used for securing wires and cords through walls of a home. However, such wall receptacles are intended to be installed at the time the home is built and/or walls are erected. Thus, a drawback to these types of apparatus is that they must be installed at the time of building the home or at least the walls involved, or they will be expensive to add thereafter. Something as simple as needing an outlet or connection in at a certain location can be an intrusive and costly fix to get the additional wiring put into place.

There is also the negative appearance of having cords hanging from devices or cables running on walls or baseboards to get to another room of the house, any of which is undesirable and distracts from the décor of the home.

Accordingly, there is a need in the art for an assembly that can provide for concealing and directing cords and wires or other similar conductors for data and electrical communication through home structures such as walls after such structures have been erected which also maintains an aesthetically desirable appearance.

### SUMMARY OF THE INVENTION

The invention is generally directed to an apparatus for disposing conductors through existing structures that solves at least some if not all of the issues cited above, among other issues not mentioned which exist in the art.

Some embodiments of the invention are directed to a conduit assembly which has an inner sleeve and outer sleeve proportioned to form a concentric engagement defining a longitudinal inner conduit having opposing flange ends surrounding opposing conduit ports.

Some embodiments of the invention are directed to a conduit assembly comprising an inner sleeve and an outer sleeve, the inner sleeve and outer sleeve being proportioned to form a concentric engagement with one another defining a longitudinal inner conduit, each of the inner sleeve and the outer sleeve having a flange end, the flange end surrounding a conduit port, wherein each of the flange ends have an inner side defining an axial shoulder and an outer side including a radially inner chamfered edge surrounding a periphery of the conduit port and a radially outer chamfered edge surrounding a periphery of the flange end.

In some embodiments of the conduit assembly, the inner sleeve comprises a first tubular sleeve body defining a first conduit therein and having a first diameter, the first tubular sleeve body including a first threading defined on an outer wall thereof.

In some embodiments of the conduit assembly, the outer sleeve comprises a second tubular sleeve body defining a second conduit therein and having a second diameter, the second tubular sleeve body including a second threading defined on an inner wall of the second conduit.

In some embodiments of the conduit assembly, the first threading and second threading cooperate to form an engagement between the first tubular sleeve body and the second tubular sleeve body, wherein the first conduit and second conduit form the longitudinal inner conduit.

In some embodiments of the conduit assembly, the first diameter is less than the second diameter.

In some embodiments of the conduit assembly, the outer wall of the first tubular sleeve body further comprises a shank portion.

Some embodiments of the invention are directed to a conduit assembly comprising an inner sleeve and an outer sleeve, the inner sleeve and outer sleeve being proportioned to form a concentric engagement with one another defining a longitudinal inner conduit, the inner sleeve comprising a first tubular sleeve body defining a first conduit therein and having a first diameter, the first tubular sleeve body including a first threading and a shank portion defined on an outer wall thereof, the outer sleeve comprising a second tubular sleeve body defining a second conduit therein and having a second diameter, the second tubular sleeve body including a second threading defined on an inner wall of the second conduit, the first diameter being less than the second diameter, wherein the first threading and second threading cooperate to form an engagement between the first tubular sleeve body and the second tubular sleeve body, whereby the first conduit and second conduit form the longitudinal inner conduit; each of the inner sleeve and the outer sleeve having a flange end, the flange end surrounding a conduit port, wherein each of the flange ends have an inner side defining an axial shoulder and an outer side including a radially inner chamfered edge surrounding a periphery of the conduit port and a radially outer chamfered edge surrounding a periphery of the flange end.

Other embodiments, features and advantages of the invention will be readily appreciated and apparent from the following detailed description when considered in connection with the accompanying drawings.

### BRIEF DESCRIPTION OF DRAWINGS

While the disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is perspective view of an embodiment of a conduit assembly of the invention;

FIG. 2 is a front view of the assembly of FIG. 1;

FIG. 3 is a side view of a first sleeve member of the assembly of FIG. 1;

FIG. 4 is a side view of a second sleeve member of the assembly of FIG. 1;

FIG. 5 is another front view of the assembly of FIG. 1; and

FIG. 6 is a depiction of the assembly of FIG. 1 installed on a wall whereby a conduit from one side of the wall to the other side of the wall is formed therein.

### DETAILED DESCRIPTION OF SOME EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

This detailed description of embodiments of the invention is not intended to be exhaustive or to limit the invention to the precise form disclosed above. While specific embodiments of, and examples for, the invention are described for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description without departing from the scope of the invention. It should be further understood that components in the figures are not necessarily to scale, and certain components are included, displayed and made part of this disclosure, but not specifically discussed herein with reference to the drawings, emphasis instead being placed upon illustrating the principles of the invention and depicted embodiments of the invention.

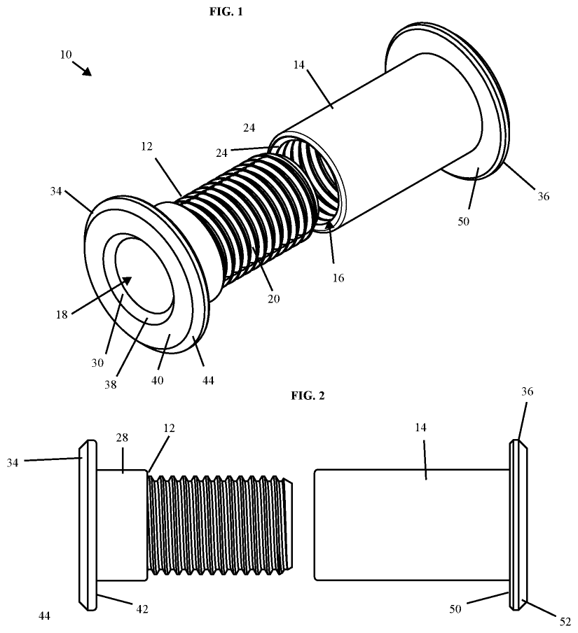

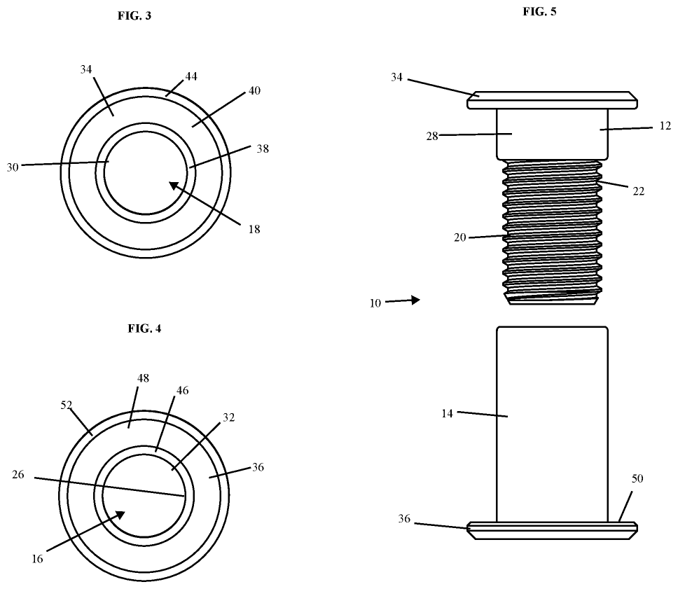

As shown in FIGS. 1-5, a wall conduit and port assembly of the invention is generally identified by the reference numeral 10.

Assembly 10 includes a tubular inner sleeve body 12 and a tubular outer sleeve body 14 configured and dimensioned to form a non-permanent engagement with outer sleeve body 14 accommodating inner sleeve body 12 within a hollow conduit 16 defined by the tubular shape and form of outer sleeve body 14. The tubular shape and form of inner sleeve body 12 also defines a hollow conduit 18 which joins together with conduit 16 upon the formation of an engagement between inner sleeve body 12 and outer sleeve body 14 which forms the assembly 10 defining a generally longitudinal conduit therein via conduits 16 and 18.

It should be understood that the tubular shape and form is shown for illustrative purposes and is non-limiting in that other shapes and forms may be employed, such as rectangular or square.

In this embodiment, the non-permanent engagement between inner sleeve body 12 and outer sleeve body 14 is facilitated by an outer threading 20 disposed on a portion of outer wall 22 of inner sleeve body 12 and a corresponding inner threading 24 disposed on a portion of an inner wall 26 of outer sleeve body 14. It should be understood that other embodiments of the invention may include other means for forming a non-permanent engagement or a permanent engagement between inner sleeve body 12 and outer sleeve body 14.

In this embodiment, inner sleeve body 12 includes a shank 28 on a portion of outer wall 22 which provides benefits including but not limited to, ease in application, application in multiple locations having different wall thicknesses and longitudinal dimensions between walls, reduced manufacturing time and cost, as well as providing sufficient rigidity and resiliency to accommodate re-use, adjustment and environmental factors such as temperature changes and home settling.

Inner sleeve body 12 and outer sleeve body 14 have a conduit port opening 30 and a conduit port opening 32 within a flange end 34 and a flange end 36, respectively. Flange end 34 includes a radially inner chamfered edge 38 about the periphery of opening 30, an intermediate ring 40 defining at least a first portion of an opposing planar shoulder 42 about the periphery of sleeve body 12 and a radially outer chamfered edge 44 at the periphery of flange end 34 also defining at least a second portion of shoulder 42. Flange end 36 includes a radially inner chamfered edge 46 about the periphery of opening 32, an intermediate ring 48 defining at least a first portion of an opposing planar shoulder 50 about the periphery of sleeve body 14 and a radially outer chamfered edge 52 at the periphery of flange end 36 also defining at least a second portion of shoulder 50.

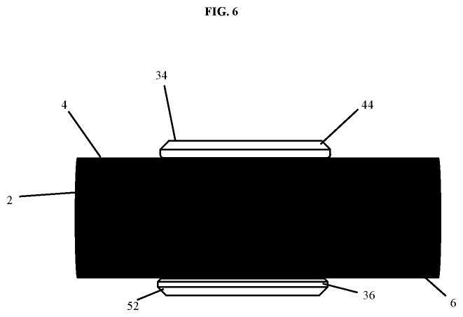

FIG. 6 illustrates assembly 10 installed in a wall 2 to form a conduit therein through the connection of conduits 16 and 18. It is envisioned that a hole was first drilled through wall 2 from side 4 to side 6 prior to inserting sleeves 12 and 14 therein, respectively. Assembly 10 advantageously enables application for a variety of wall dimensions and thicknesses between side 4 and side 6. As shown, responsive to the engagement of sleeves 12 and 14 (via rotating sleeves 12 and 14 relative to one another to engage threads 20 and 24, respectively), shoulder 42 of flange end 34 comes into contact with, and is urged against, side 4 of wall 2. Responsive to the engagement of sleeves 12 and 14, shoulder 50 of flange end 36 comes into contact with, and is urged against, side 6 of wall 2. Outer chamfered edges 44 and 52 provide an aesthetically appealing appearance, among other things, and inner chamfered edges 38 and 46 facilitate ease in inserting cables, wires or cords through conduits 16 and 18, respectively.

It should be understood that sleeves 12 and 14 may be constructed of various materials, such as metals, carbon fiber and polymers, including plastics, such as polyvinyl chloride, and be formed in various lengths and diameters to secure wires, cables, cords and the like through various wall thicknesses. For example, the diameters of sleeves 12 and 14 may accommodate forming conduits having about a one inch inner diameter to about a five inch inner diameter, and lengths accommodate walls having thickness between 3 inches and 12 inches.

Embodiments of the invention provide an assembly for providing a wall port that is an aesthetically appealing system for enabling the running of cables, cords, wires, tubes, etc., through a wall from one room to another. The dual sleeves with threads allows the assembly of the invention to accommodate a variety in wall thickness.

While exemplary apparatus, systems and methods of the invention have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth herein, and in the claims, and any equivalents thereto.

1. A conduit assembly comprising an inner sleeve and an outer sleeve, the inner sleeve and outer sleeve being proportioned to form a concentric engagement with one another defining a longitudinal inner conduit, each of the inner sleeve and the outer sleeve having a flange end, the flange end surrounding a conduit port, wherein each of the flange ends have an inner side defining an axial shoulder and an outer side including a radially inner chamfered edge surrounding a periphery of the conduit port and a radially outer chamfered edge surrounding a periphery of the flange end.

2. The conduit assembly of claim 1, wherein the inner sleeve comprises a first tubular sleeve body defining a first conduit therein and having a first diameter, the first tubular sleeve body including a first threading defined on an outer wall thereof.

3. The conduit assembly of claim 2, wherein the outer sleeve comprises a second tubular sleeve body defining a second conduit therein and having a second diameter, the second tubular sleeve body including a second threading defined on an inner wall of the second conduit.

4. The conduit assembly of claim 3, wherein the first threading and second threading cooperate to form an engagement between the first tubular sleeve body and the second tubular sleeve body, wherein the first conduit and second conduit form the longitudinal inner conduit.

5. The conduit assembly of claim 4, wherein the first diameter is less than the second diameter.

6. The conduit assembly of claim 5, wherein the outer wall of the first tubular sleeve body further comprises a shank portion.

6. A conduit assembly comprising an inner sleeve and an outer sleeve, the inner sleeve and outer sleeve being proportioned to form a concentric engagement with one another defining a longitudinal inner conduit, the inner sleeve comprising a first tubular sleeve body defining a first conduit therein and having a first diameter, the first tubular sleeve body including a first threading and a shank portion defined on an outer wall thereof, the outer sleeve comprising a second tubular sleeve body defining a second conduit therein and having a second diameter, the second tubular sleeve body including a second threading defined on an inner wall of the second conduit, the first diameter being less than the second diameter, wherein the first threading and second threading cooperate to form an engagement between the first tubular sleeve body and the second tubular sleeve body, whereby the first conduit and second conduit form the longitudinal inner conduit; each of the inner sleeve and the outer sleeve having a flange end, the flange end surrounding a conduit port, wherein each of the flange ends have an inner side defining an axial shoulder and an outer side including a radially inner chamfered edge surrounding a periphery of the conduit port and a radially outer chamfered edge surrounding a periphery of the flange end.
